(19) United States
(12) Patent Application Publication
(10) Pub. No.: US 2017/0320556 A1
(43) Pub. Date: Nov. 9, 2017

(54) TRANSLUCENT PANEL SYSTEM

(71) Applicant: VISION SYSTEMS, Brignais (FR)

(72) Inventors: Laurent Costa, Lyon (FR); Georges Figura, Brignais (FR)

(21) Appl. No.: 14/901,052

(22) PCT Filed: Jun. 18, 2014
(86) PCT No.: PCT/FR2014/051511

§ 371 Date: Dec. 27, 2015

(30) Foreign Application Priority Data
Jun. 28, 2013 (FR) 1356294

(51) Int. Cl. B64C 1/14; E06B 9/24; G02B 5/30; G02F 1/01

(52) U.S. Cl. CPC B64C 1/14; G02F 1/0136; E06B 9/24; G02B 5/30

(57) ABSTRACT

A translucent panel system comprising a panel (13) comprising a translucent layer provided with a transparent screen on which there is mounted a device having sensors sensing light energy from a light source, so as to allow viewing through the translucent layer, the panel (13) further comprising an internal layer provided with a polarisable film intended to modify the degree of opacity of the panel (13), the translucent layer being opposite the internal layer. The translucent panel system comprises an element for transmitting and/or storing energy originating from the device having sensors and a system for supplying power and adjusting the degree of opacity of the polarisable film, the power supply and adjustment system being at least partially supplied by the element for transmitting and/or storing light energy.

### TECHNICAL FIELD

The present invention relates to the field of portholes, or glazings or translucent walls comprising a polarizable film arranged to vary the occultation degree of the light passing through said porthole.

### BACKGROUND

It is known to use a translucent panel system comprised in the porthole. The translucent panel system comprises a polarizable film disposed on an internal layer of the translucent panel, the polarizable film being arranged to vary the degree of opacity of the porthole.

The degree of opacity of the porthole can vary from transparency to full opacity. To do this, the polarizable film comprises two polarized conductive layers between which is disposed a polarizable material layer. This polarizable material layer is subject to a potential difference by the conductive layers. The variation of the power supply voltage causes the variation of the degree of opacity or darkening. Thus it is possible to set the luminous intensity passing through the porthole. This system is satisfactory in that the degree of opacity of the porthole can be adjusted according to the external brightness.

However, such a system requires an arrangement for power supply and setting of the degree of opacity. The power supply of the porthole depends on either an external supply of electrical network type or an energy reserve of battery type.

In this respect, the autonomy of the panel system is dependent on an external exhaustible power source or likely to no longer provide power in the event of failure.

### BRIEF SUMMARY

The present invention aims to completely or partly overcome the aforementioned drawbacks.

In the present text, verbs “join”, “connect”, “link”, “supply” and their derivatives are related to an electrical communication between two distinct components.

To this end, the present invention relates to a translucent panel system comprising a panel. The panel comprises a translucent layer provided with a transparent screen on which is attached a luminous energy sensor device for sensing a light source, so as to allow viewing through the translucent layer, the panel further comprising an internal layer provided with a polarizable film intended to modify the degree of opacity of the panel, the translucent layer being opposite to the internal layer.

The panel system comprises an element for transmitting and/or storing energy coming from the sensor device.

The panel system comprises an arrangement for power supply and setting of the degree of opacity of the polarizable film, the supply and setting arrangement being at least partially supplied by the transmission and/or storage element of the luminous energy.

Due to the dispositions according to the invention, it is possible to form an assembly wherein the power supply of the system is at least partly ensured by the luminous energy sensor device.

According to another aspect of the invention, the transmission and/or storage element is arranged to transfer the energy transmitted or stored to an outer element suitable for consuming it.

Preferably, the outer element is an electrical circuit distinct from the panel system.

According to one aspect of the invention, the luminous energy sensor device comprises thermal and/or photovoltaic solar sensors.

According to one aspect of the invention, the photovoltaic solar sensors are attached on the transparent screen and are arranged so that the transparent layer has a transparency greater than 60%.

Preferably, the photovoltaic solar sensors are arranged so that the transparent layer has a transparency ranging between 60% and 90%.

According to one aspect of the invention, the photovoltaic solar sensors are attached on the transparent screen and are arranged to obtain a conversion efficiency of the solar energy into electrical power higher than 4%. Preferably, the conversion efficiency ranges between 4 and 40%.

According to another aspect of the invention, a selective material removal from the photovoltaic sensors attached on the transparent screen is carried out to produces the translucent layer.

The selective material removal allows an increase of the transparency of the translucent layer.

According to one aspect of the invention, the transmission and/or storage element of the luminous energy comprises a battery suitable for storing energy from the sensor device.

According to one aspect of the invention, the polarizable film is opaque in absence of a power supply.

Preferably, the degree of opacity of the polarizable film decreases with the power supply voltage increase.

According to one aspect of the invention, the polarizable film is of the type “suspended particle device”. A polarizable film of the type “suspended particle device” has a reactivity to electric power variations, imparting it with a quick adaptation to brightness change.

The polarizable film being opaque in absence of a power supply, the use of batteries has a definite advantage. In period of high brightness, the power supply necessary for the polarizable film is low while the power sensor device recovers significant energy. Thus, it is possible to charge the batteries.

Conversely, in period of low brightness, the power supply needs are greater and the recovered energy is lower. The stored energy in the battery can then be used for the power supply.

According to one aspect of the invention, the supply and setting arrangement is supplied by the transmission and/or energy storage element.

This disposition allows autonomous operation of the panel system, that is to say, without supplying energy from the power supply circuit.

Preferably, the supply and setting arrangement is supplied by the batteries.

The polarizable film being more opaque in the absence of a power supply and less opaque in the presence of a power supply, the use of batteries allows storing energy during a period of high brightness, the necessary power for the polarizable film being low. Conversely, during a period of low brightness, the power supply needs are greater and the recovered energy is lower. The energy stored in the battery may thus be used for the power supply of the polarizable film.

However, joining to the power supply circuit of the aircraft provides additional safety, in case of absence of energy in the batteries.

According to one aspect of the invention, the internal layer further comprises at least one additional polarizable film intended to modify the degree of opacity of the panel.

The presence of two polarizable films allows a finer setting of the degree of opacity of the internal layer. This disposition allows a better adjustment of the darkening achieved by the internal layer according to the incident lighting.

According to one aspect of the invention, the translucent layer is contiguous to the layer comprising the polarizable film.

According to one aspect of the invention, the translucent panel system further comprises a first and a second end wall surrounding the translucent and internal layers.

According to one aspect of the invention, the first and second end walls are opposite to the translucent and external layers. Preferably, the first end wall is contiguous to the internal layer and the second end wall is contiguous to the translucent layer.

According to one aspect of the invention, the first and the second outer walls are transparent.

According to one aspect of the invention, the translucent panel system comprises an electrical circuit provided with a processing unit arranged to control the power supply and setting arrangement.

According to one aspect of the invention, the translucent panel system comprises control elements electrically linked to the processing unit and arranged to transmit a setting control of the degree of opacity of the polarizable film by a user.

According to one aspect of the invention, the control elements are attached on the electrical circuit. Preferably, the control elements comprise tactile keys arranged to be controlled by the user through the first end wall attached on the panel.

According to one aspect of the invention, the translucent panel system further comprises a receiving cassette.

The receiving cassette comprises a first housing intended to receive at least a part of the luminous energy transmission or storage element and a second housing intended to receive at least a part of the power supply and setting arrangement of the degree of opacity of the polarizable film.

### BRIEF DESCRIPTION OF THE INVENTION

In any case the invention will be better understood using the following description with reference to the accompanying schematic drawings representing, by way of non-limiting example, an embodiment of this translucent panel system.

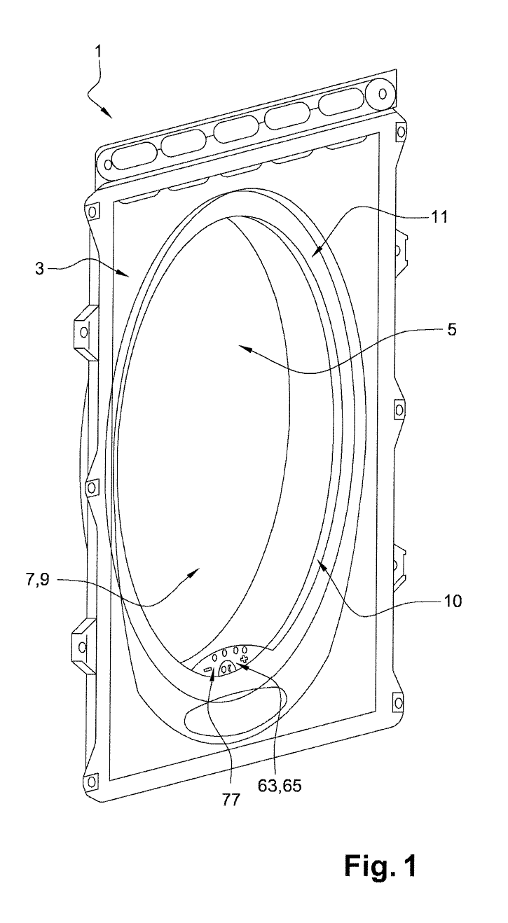

FIG. 1 is a perspective view of a cassette for receiving a porthole, according to a first embodiment.

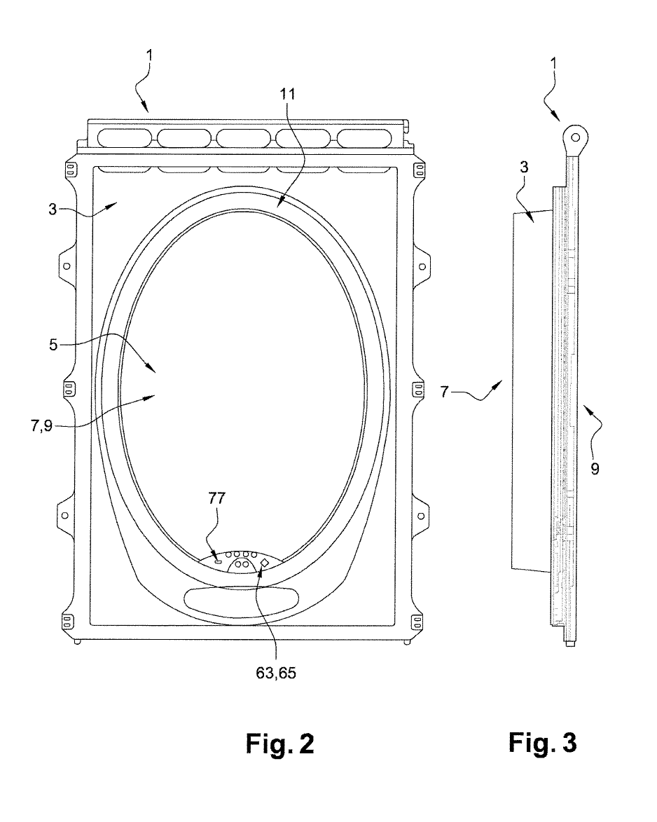

FIG. 2 is a front view of the cassette for receiving the porthole, according to the first embodiment.

FIG. 3 is a side view of the cassette for receiving the porthole, according to the first embodiment.

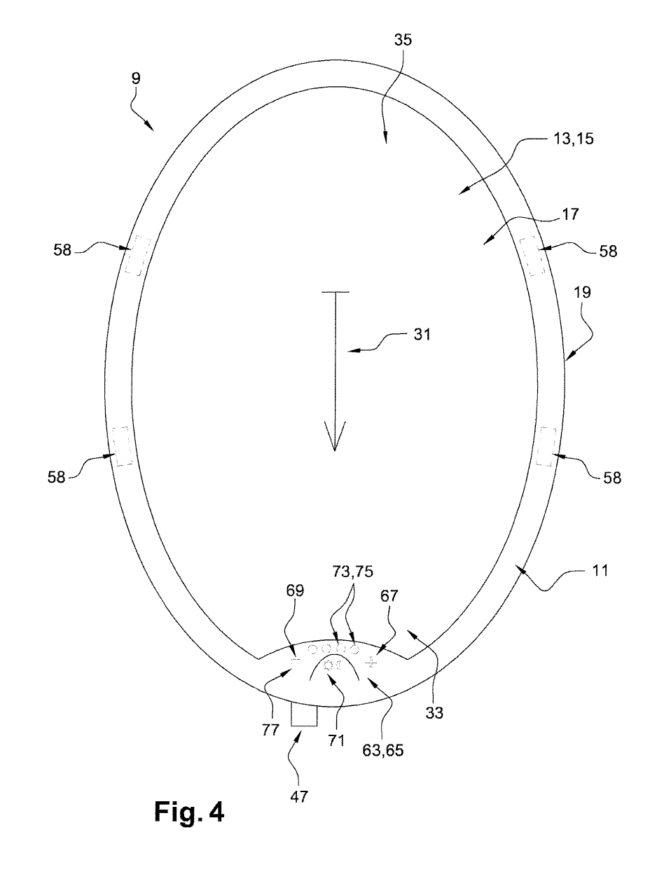

FIG. 4 is a front view of an inner trim porthole comprising a polarizable film according to the first embodiment.

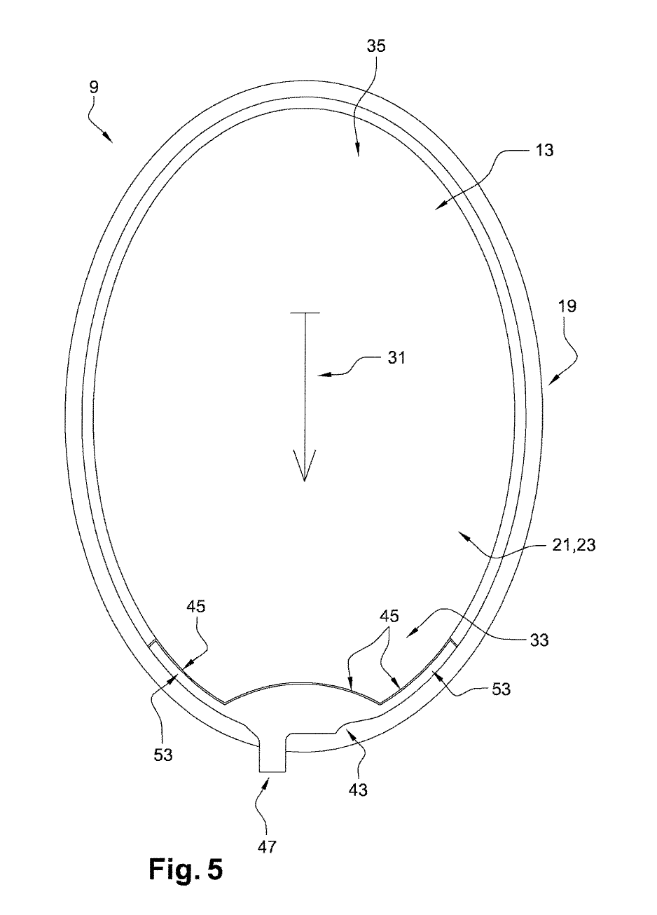

FIG. 5 is a sectional view of the inner trim porthole comprising a control sub-assembly, according to the first embodiment.

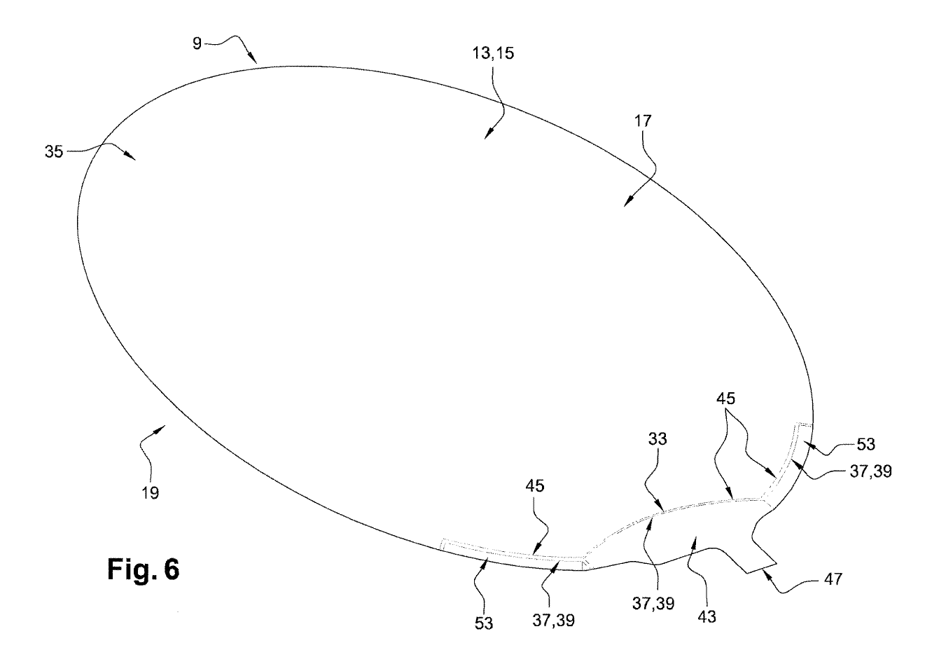

FIG. 6 is a perspective view of the inner trim porthole, according to the first embodiment.

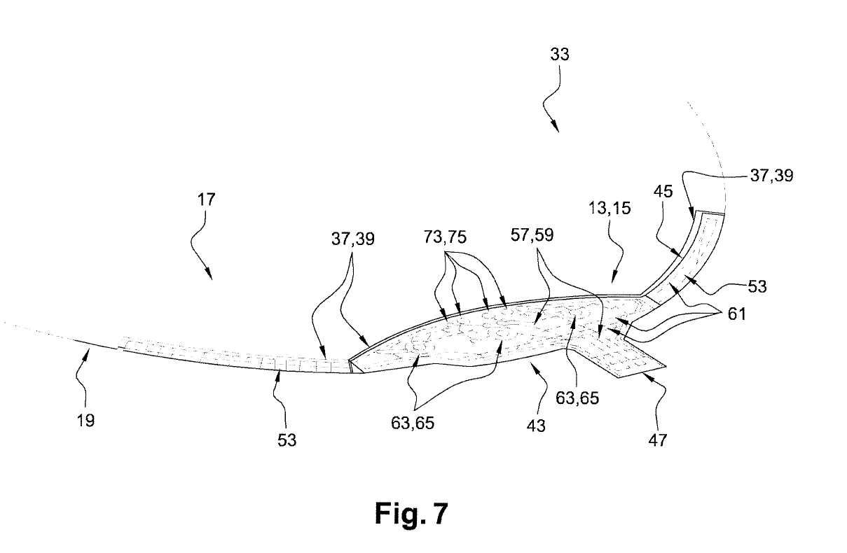

FIG. 7 is a perspective view of the control sub-assembly according to the first embodiment.

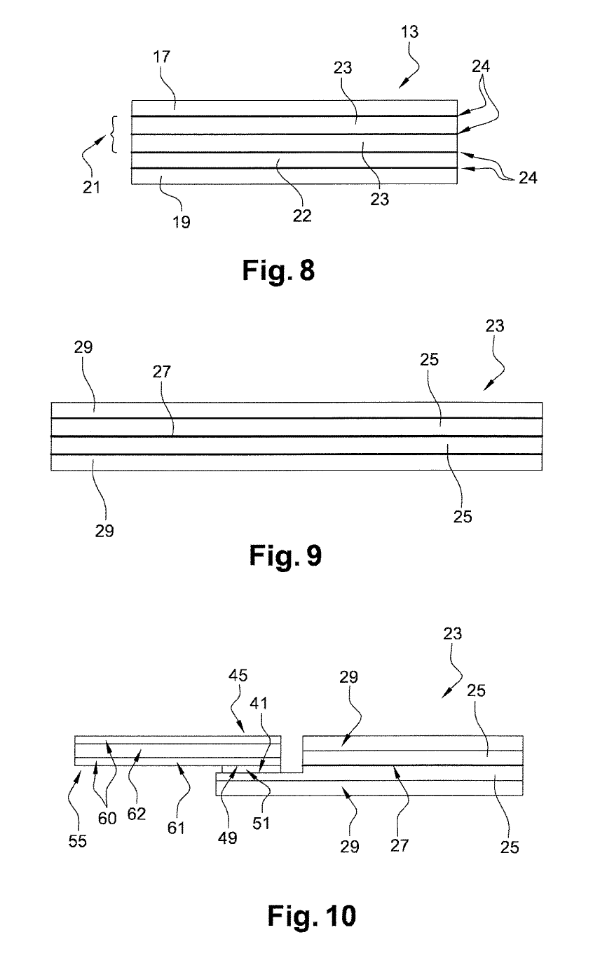

FIG. 8 is a sectional view of a panel of the inner trim porthole.

FIG. 9 is a sectional view of a polarizable film, according to the first embodiment.

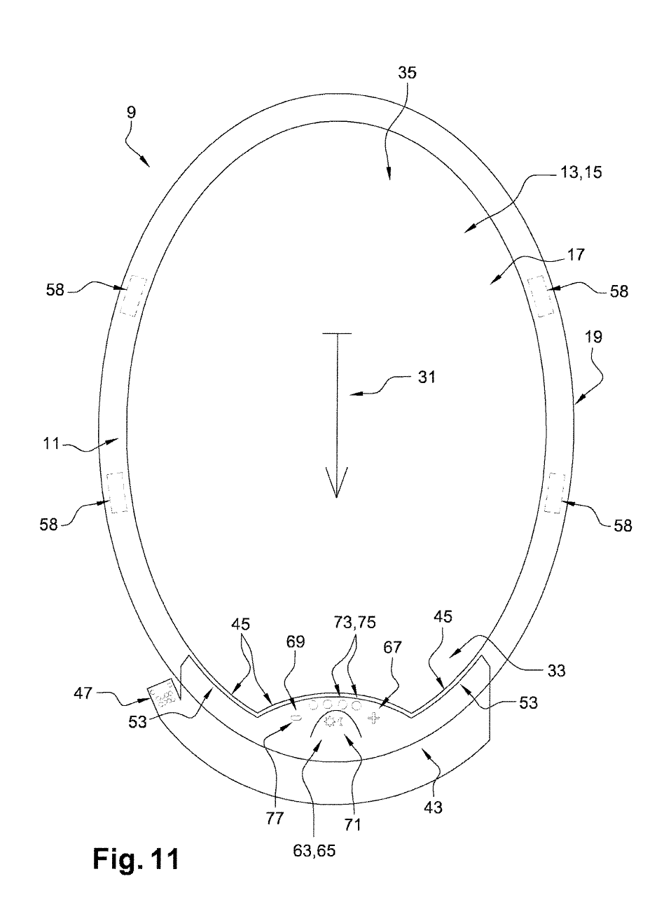

FIG. 10 is a sectional view of a bonding of a conductive track to a polarizable film according to the first embodiment.

FIG. 11 is a sectional view of the inner trim porthole comprising a control sub-assembly according to a second embodiment.

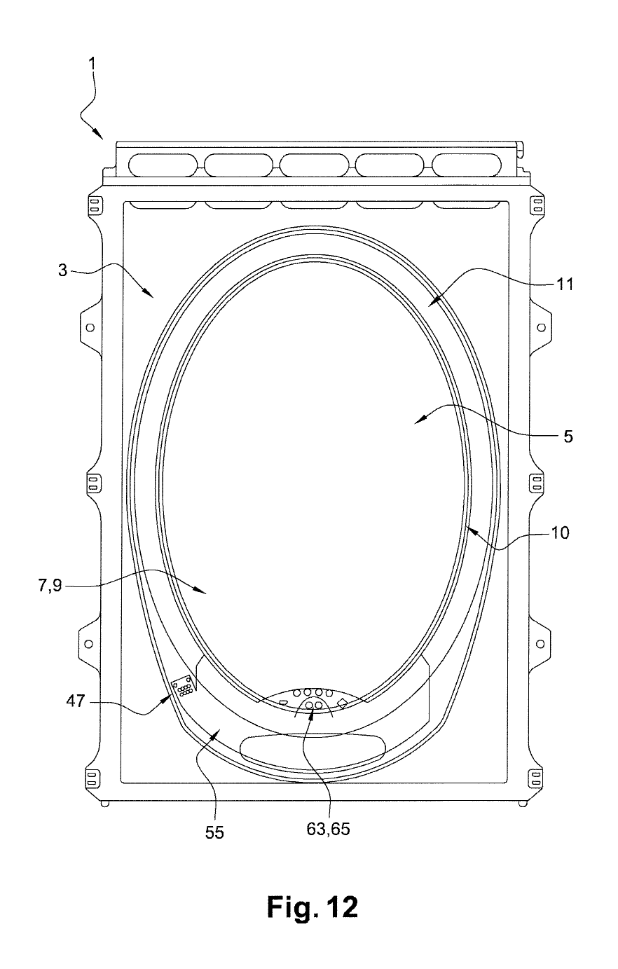

FIG. 12 is a front view of the cassette for receiving the porthole, according to the second embodiment.

### DETAILED DESCRIPTION

As illustrated in FIGS. 1 to 3 and according to the first embodiment, a translucent panel system 1 of the polarizable porthole for an aircraft comprises a cassette 3 for receiving a porthole. An opening 5 is arranged in the receiving cassette 3. The system 1 also comprises an outer structural porthole and an inner trim porthole 9.

The non represented outer structural porthole intended to be positioned in a location designated by the reference 7 is located on the side of the receiving cassette 3 facing the outside of the aircraft and the inner trim porthole 9 is located on the side of the receiving cassette 3 facing the inside of the aircraft. The outer structural porthole is remote from the inner trim porthole 9.

The system 1 further comprises a ring 11 for retaining the inner trim porthole 9 in a housing 10 of the receiving cassette 3. The shape of the retaining ring 11 corresponds to the contour of the inner trim porthole 9.

The retaining ring 11 is provided with a removable fastening member on the receiving cassette 3. The retaining ring 11 is arranged for retaining the inner trim porthole 9 in position when the removable fastening member secures the retaining ring 11 to the receiving cassette 3.

As illustrated in FIG. 4, the inner trim porthole 9 comprises a panel 13. The panel 13 is substantially planar and has an ovoid-shaped contour. The panel 13 comprises a plurality of layers and has a thickness resulting from the stacking of said layers.

Thus, it can be distinguished a first outer face 15 of the panel 13 facing towards the inside of the aircraft and a second outer face of the panel 13 being opposite to the structural outer porthole.

The panel 13 comprises a plurality of layers. The panel 3 comprises two end walls 17, 19 made of a translucent material. According to the shown embodiment the translucent material is a polycarbonate.

The panel 13 comprises an internal layer 21 and a translucent layer 22 secured together by a transparent adhesive layer 24.

The internal layer 21 and the translucent layer 22 are surrounded by the end walls 17, 19. The internal layer 21 is secured to the first end wall 17, the securing being achieved by a transparent adhesive layer 24. Similarly, the translucent layer 22 is secured to the second end wall 19, the securing being achieved by a transparent adhesive layer 24.

The translucent layer 22 comprises a transparent screen extending opposite to the walls 17, 19. A luminous energy sensor device, for example of the same type as that described in document WO 2007085721 A1, is attached on a surface of the transparent screen, but other energy sensor structures are possible.

The luminous energy sensor device comprises a plurality of photovoltaic solar sensors. Photovoltaic areas can be defined by adding the photovoltaic sensors on the transparent screen.

According to a variant, it is possible to increase the transparency of the translucent layer 22 by selective material removal in the photovoltaic areas.

The advantage of the translucent layer 22 is that it comprises a plurality of photovoltaic sensors while allowing the passage of light.

The used photovoltaic sensors can be of any type as long as their conversion efficiency ranges between 4 and 40% and their transparency preferably ranges between 60 and 90%.

The photovoltaic areas preferably have dimensions and shapes suitable for reducing their visibility with respect to human eye resolution and limiting blurring as well as diffraction phenomena which could disturb the visibility through the porthole.

As illustrated in FIGS. 5 and 8, the internal layer 21 comprises at least one polarizable film 23. According to the first embodiment, the internal layer 21 comprises two superposed polarizable films 23. A transparent adhesive layer 24 ensures the securing between the two polarizable films 23.

Each polarizable film 23 forms a thickness of the internal layer 21 and extends opposite to the outer faces 15 of the inner trim porthole 9.

Furthermore, the polarizable films 23 are arranged so that their respective degrees of opacity may be independently modified.

As illustrated in FIG. 9, each polarizable film 23 comprises two transparent conductive layers 25 between which there is a layer made of a polarizable material 27. The conductive layers 25 also extend opposite to the outer faces 15 of the inner trim porthole 9.

According to the first embodiment, the polarizable material layer 27 is of the “suspended particle device” type. The polarizable material layer 27 is arranged to change the degree of opacity depending on the power supply imposed on said material by the two conductive layers 25 surrounding it. The degree of opacity is obtained by a polarization of said material, the polarization varying depending on the power supply subjected to the two conductive layers 25.

The conductive layers 25 are surrounded by transparent insulating layers 29. According to the first embodiment, the transparent insulating layers 29 are made of polyamide.

As illustrated in FIGS. 1 to 6, the ovoid shape of the inner trim porthole 9 has a main direction of extension 31. A first 33 and a second end 35 of the inner trim porthole 9 along the main direction of extension 31 are defined.

At the first end 33 of the inner trim porthole 9, the internal layer 21 and the translucent layer 22 comprise a connection station 37, as illustrated in FIGS. 6 and 7. The connection station 37 comprises a connection location 39 arranged in the thickness of the internal 21 and translucent 22 layers.

The connection station 37 comprises contact areas 41 intended for those of the internal layer 21 for the power supply of the conductive layers 25 and for those of the translucent layer 22 for the electrical power recovery from the energy sensor device. Each conductive layer 25 comprises a contact area 41.

As illustrated in FIGS. 6 and 7, the inner trim porthole 9 further comprises a control sub-assembly 43. The control sub-assembly 43 is attached to the first end 33 of the inner trim porthole 9.

The retaining ring 11 is opposite the control sub-assembly 43 so that the retaining ring 11 carries out the capping of the control sub-assembly 43 with respect to the inside of the aircraft.

The control sub-assembly 43 comprises a first electrical linking member 45 and a second electrical linking member 47. The first 45 and the second 47 linking members are made of flexible material.

The control sub-assembly 43 is located between the walls 17, 19, except for the second electrical linking member 47 which extends towards the outside of the inner trim porthole 9.

The first electrical linking member 45 has an outer shape complementary to the connection location 39. The first electrical linking member 45 is secured to the dock station by bonding.

As illustrated in FIG. 10, the first electrical connection member 45 comprises connection terminals 49 to the contact areas 41 of the connection station 37. The bonding 51 allows both securing the control sub-assembly 43 to the connection station 37 and electrically linking the contact areas 41 to the connection terminals 49. FIG. 10 illustrates a bonding 51 between a conductive layer 25 and a connection terminal 49 of the first electrical connection member 45.

As illustrated in FIGS. 6 and 7, the first electrical connection member 45 comprises two lateral strips 53.

The second electrical connection member 47 extends outside the area opposite to the walls 17, 19 unlike the remainder of the control sub-assembly 43, as illustrated in FIG. 7. The second connection member 47 extends substantially parallel to the outer faces 15 of the panel 13. The second connection member 47 comprises a connection element to a power supply circuit.

As illustrated in FIG. 7, the control sub-assembly 43 comprises a flexible electrical circuit 55. The electrical circuit 55 further comprises a processing unit 57. According to the first embodiment, the processing unit 57 is a microprocessor. The microprocessor is arranged in the flexible electrical circuit 55.

The control sub-assembly 43 comprises an energy transmission and storage element provided with batteries 58. The batteries 58 are disposed in housings of the retaining ring 11, the retaining ring 11 carrying out a capping of the batteries 58 with respect to the inside of the aircraft as illustrated in FIGS. 4, 5 and 11.

The transmission and storage element is arranged to transmit the electrical power recovered by the luminous energy sensor device to the batteries 58.

The control sub-assembly 43 comprises a power supply and setting arrangement of the degree of opacity of the polarizable film 59 applying a voltage to the terminals of the first connection member, the device being arranged in the flexible electrical circuit. The voltage application device is linked to an external power supply by the second connection member.

The microprocessor and the power and setting arrangement 59 are connected, the microprocessor being arranged to guide the power and setting arrangement 59 so that the supply and setting arrangement 59 makes the power supply vary at the terminals 49 of the first electrical connection member 45. As illustrated in FIG. 10, the power and setting arrangement 59 is electrically linked to the first linking member 45 by conductive tracks 61, the conductive tracks 61 being disposed in a conductive portion 60 of the flexible electrical circuit 55. The electrical circuit 55 also comprises an insulating portion 62.

The control sub-assembly 43 is arranged to supply electrical power to the conductive layers 25 through the power supply and setting arrangement 59 with electrical power from the batteries.

The control sub-assembly 43 also comprises control elements 63 attached on the flexible electrical circuit 55. The control elements 63 are linked to the microprocessor so as to allow a user to set the power supply of the conductive layers 25.

The control elements 63 comprise tactile keys 65 arranged to be controlled by the user through the first wall 17, the tactile keys 65 being activated by contact on an area of the first outer face 15 opposite to the touch-sensor button 65. The tactile keys 65 comprise inductive and/or capacitive sensors.

The control elements 63 comprise a first tactile key 67 for increasing the degree of opacity of the inner trim porthole 9, a second tactile key 69 for decreasing said degree of opacity and a third tactile key 71 allowing with each push to alternate between full opacity and transparency of the inner trim porthole 9.

The control sub-assembly 43 also comprises signaling elements 73 attached on the flexible electrical circuit 55. The signaling elements 73 comprise light-emitting diodes 75 visible through the first wall 17, as illustrated in FIG. 7.

The light-emitting diodes 75 are electrically linked to the microprocessor. The microprocessor is arranged to guide the lighting of the light-emitting diodes 75 depending on the degree of opacity of the porthole. The number of lighted light-emitting diodes 75 varies depending on the degree of opacity of the inner trim porthole 9, the more opaque the inner trim porthole 9 is the higher the number of lighted light-emitting diodes 75.

The control sub-assembly 43 also comprises a screen printing 77 disposed on the flexible electrical circuit 55, as illustrated in FIG. 7. The screen printing 77 comprises indications intended for the user to specify the location of the tactile keys 65 and the role thereof. Openings are formed in the screen printing to keep the light-emitting diodes 75 exposed.

As illustrated in FIGS. 11 and 12, according to a second embodiment, the electrical circuit 55 has a portion outside the area opposite to the walls 17, 19. The electronic circuit 55 is partially stiff and partially flexible.

The stiff portion of the electronic circuit comprises the second electrical linking member 47. The stiff portion of the electronic circuit 55 also comprises the processing unit 57 and the power and setting arrangement 59 for the transmission of the electrical power to the conductive layers 25.

The flexible portion comprises the first electrical linking member 45, the control elements 63 and the signaling elements 73.

The conductive tracks 61 are comprised in both the stiff portion and the flexible portion.

Only the features of the second embodiment differing from the first embodiment elements are described hereinabove. The identical features are not repeated.

The inner trim porthole 9 described hereinabove has advantages given its design. The control sub-assembly 43 is attached to the panel 13 of the inner trim porthole 9. The insertion of the inner trim porthole 9 in the housing 10 of the receiving cassette 3 is thus made easier.

The installation of the inner trim porthole 9 in the receiving cassette 3 is rapid and easy: all that needs to be done is to position the inner trim porthole 9 in the dedicated location of the receiving cassette 3, join the second electrical linking member 47 to a power source and to secure the electrical and inner trim porthole 9 with the retaining ring 11.

For maintenance operations, particularly in case of malfunction of the setting of the degree of opacity, replacing the defective inner trim porthole 9 with another inner trim porthole 9 also proves to be easy due to the integration of the control sub-assembly 43 in the inner trim porthole 9.

The inner trim porthole 9 is also reliable as the control sub-assembly 43 is protected from the outside environment by the retaining ring 11.

In addition, the electrical joining by bonding the first electrical linking member 45 to the connection station 41 is resistant. The break risk of the electrical connection is low.

The polarizable film 23 is opaque in absence of the power supply, the use of batteries 58 has a definite advantage. In period of high brightness, the power supply necessary for the polarizable film is low whereas the energy sensor device recovers significant energy. Thus it is possible to charge the batteries 58.

Conversely, during a period of low brightness, the power supply needs are greater and the recovered energy is lower. The energy stored in the batteries can then be used for the power supply.

This disposition allows autonomous operation of the panel system 1, that is to say, without supplying energy from the power supply circuit. However, joining the power supply circuit of the aircraft provides additional safety, in case of absence of energy in the batteries.

As it is known per se, the invention is not limited to the only embodiment of this system, described above by way of example, it encompasses, on the contrary, all the variants.

In this respect, the luminous energy sensor device may be provided with different types of luminous energy recovery sensors, as for example thermal solar sensors instead of photovoltaic sensors.

1. A translucent panel system comprising:
a panel comprising a translucent layer provided with a transparent screen on which is attached a luminous energy sensor device, for sensing a light source, so as to allow viewing through the translucent layer, the panel further comprising an internal layer provided with a polarizable film intended to modify the degree of opacity of the panel, the translucent layer being opposite the internal layer,
element for transmitting and/or storing energy coming from the sensor device.
an arrangement for power supply and setting of the degree of opacity of the polarizable film, the supply and setting arrangement being at least partially supplied by the transmission and/or storage element of the luminous energy.

2. The translucent panel system according to claim 1, wherein the luminous energy sensor device comprises thermal and/or photovoltaic solar sensors.

3. The translucent panel system according to the preceding claim 2, wherein the photovoltaic solar sensors are attached on the transparent screen and are arranged so that the transparent layer has a transparency greater than 60%.

4. The translucent panel system according to claim 1, wherein the transmission and/or storage element of the luminous energy comprises a battery suitable for storing energy from the sensor device.

5. The translucent panel system according to claim 1, wherein the polarizable film is opaque in absence of a power supply.

6. The translucent panel system according to claim 1, wherein the supply and setting arrangement is supplied by the transmission and/or energy storage element.

7. The translucent panel system according to claim 1, wherein the internal layer further comprises at least one additional polarizable film intended to modify the degree of opacity of the panel.

8. The translucent panel system according to claim 1, wherein the translucent layer is contiguous to the layer comprising the polarizable film.

9. The translucent panel system according to claim 1, further comprising a first and second end wall surrounding the translucent and the internal layers.

10. The translucent panel system according to claim 1, comprising an electrical circuit provided with a processing unit arranged to control the power and setting arrangement.

11. The translucent panel system according to claim 10, comprising control elements electrically linked to the processing unit and arranged for transmitting a setting control of the degree of opacity of the polarizable film by a user.

12. The translucent panel system according to claim 1 further comprising a receiving cassette,
the receiving cassette comprising a first housing intended to at least partly receive the transmission or storage element of the luminous energy and a second housing intended to receive at least partly the arrangement for the supply and setting of the degree of opacity of the polarizable film.
